(19) United States
(12) Patent Application Publication
(10) Pub. No.: US 2017/0100702 A1
(43) Pub. Date: Apr. 13, 2017

(54) Rotary Mixer

(71) Applicant: Sabia Inc., San Diego, CA (US)

(72) Inventors: Stephen James Foster, Vista, CA (US); James Francis Miller, Solana Beach, CA (US); Clinton LaMar Lingren, San Diego, CA (US); Terry Lynn Burke, II, Idaho Falls, ID (US)

(21) Appl. No.: 14/881,706

(22) Filed: Oct. 13, 2015

(51) Int. Cl. B01F 9/06; B01F 3/18

(52) U.S. Cl. CPC B01F 9/06; B01F 3/188; B01F 2009/0092

(57) ABSTRACT

The subject matter of this specification can be embodied in, among other things, a rotary mixer with a housing defining a mixing chamber defining a rotation axis, the housing being rotatable about the rotation axis in a rotation direction and having a longitudinal midpoint, a set of blades within the housing, wherein at least one pair of blades of the set of blades forms an angle with respect to each other, and at least one blade of the set of blades is shorter than another blade of the set of blades in the rotation direction, and a splitter blade located within the housing with respect to the longitudinal midpoint and the angle to divide material in the mixing chamber between the at least one blade of the set of blades and the other blade of the set of blades, as the cylindrical housing is rotated about the rotation axis.

### TECHNICAL FIELD

This specification relates to apparatus for mixing particulate matter.

### BACKGROUND

Mixing of solids, such as powders and aggregates, is a common operation in many industries. Examples can be found in the manufacturing of chemical products (gas-solid reaction), pharmaceuticals (preparation of drugs), foods (freeze-dried products), cosmetics (preparation of makeup), construction products (concrete in truck mixers), and detergents (homogenization of washing powders). The aim of these operations is to homogenize two or more components. Such homogenization can be difficult due to the diversity of products in terms of size (particles, granules or lumps), shape (spheres, pellets, flakes, filaments, blocks, crystals or irregularly shaped particles), moisture (dry product, wet product or paste), and surface nature (cohesive or non-cohesive powder).

### SUMMARY

In general, this document includes systems, apparatus and techniques for mixing particulate matter.

In a first aspect, a rotary mixer includes a cylindrical housing having a peripheral wall defining a mixing chamber having a first axial end and a second axial end and defining a rotation axis, the cylindrical housing being rotatable about the rotation axis in a rotation direction and having a longitudinal midpoint, a set of blades within the cylindrical housing, wherein at least one pair of blades of the set of blades forms an angle with respect to each other, and at least one blade of the set of blades is shorter than another blade of the set of blades in the rotation direction, and a splitter blade located within the cylindrical housing with respect to the longitudinal midpoint and the angle to divide material in the mixing chamber between the at least one blade of the set of blades and the other blade of the set of blades, as the cylindrical housing is rotated about the rotation axis.

Various embodiments can include some, all, or none of the following features. The at least one pair of blades can include a first wedge blade and a second wedge blade, the first wedge blade being attached to the peripheral wall proximal to the first axial end to a location on the peripheral wall away from the first axial end and extending inward toward the rotation axis, and the second wedge blade being attached to the peripheral wall proximal to the second axial end to a location on the peripheral wall away from the second axial end and extending inward toward the rotation axis. The at least one pair of blades can include a third wedge blade and a fourth wedge blade, the third wedge blade being attached to the peripheral wall proximal to the first axial end to a location on the peripheral wall away from the first axial end and extending inward toward the rotation axis, and the fourth wedge blade being attached to the peripheral wall proximal to the second axial end to a location on the peripheral wall away from the second axial end and extending inward toward the rotation axis. The at least one pair of blades can include the at least one blade of the set of blades and the other blade of the set of blades, which are a first lifter blade and a second lifter blade that come together to form a v-channel. The set of blades can include a first wedge blade and a second wedge blade, the first wedge blade being attached to the first lifter blade and to the peripheral wall proximal to the first axial end, and the second wedge blade being attached to the second lifter blade and to the peripheral wall proximal to the second axial end. The v-channel can be a first v-channel, and the at least one pair of blades can include a third lifter blade and a fourth lifter blade that come together to form a second v-channel suspended radially between the first v-channel and the cylindrical housing. The at least one pair of blades can include a third lifter blade and a fourth lifter blade that come together to form a second v-channel. The set of blades can include a first wedge blade and a second wedge blade, the first wedge blade being attached to the third lifter blade and to the peripheral wall proximal to the first axial end, and the second wedge blade being attached to the fourth lifter blade and to the peripheral wall proximal to the second axial end. The at least one pair of blades can include a fifth lifter blade and a sixth lifter blade that come together to form a third v-channel suspended radially between the second v-channel and the cylindrical housing.

In a second aspect, a method of mixing particulate matter includes providing a particulate mix including one or more particulates within a cylindrical housing having a peripheral wall defining a mixing chamber having a first axial end and a second axial end and defining a rotation axis, the cylindrical housing being rotatable about the rotation axis extending between the first axial end and the second axial end and having a longitudinal midpoint, and at least one set of blades within the cylindrical housing, rotating the cylindrical housing about the rotation axis, separating, by rotational motion of the set of blades about the rotation axis, the particulate mix into a first portion and a second portion, lifting, by rotational motion of the set of blades about the rotation axis, the first portion above the second portion, directing, by rotational motion of the set of blades about the rotation axis, the first portion toward the midpoint, directing, by rotational motion of the set of blades about the rotation axis, the second portion toward the midpoint, and depositing, by rotational motion of the set of blades about the rotation axis, the first portion on top of the second portion.

Various embodiments can include some, all, or none of the following features. The set of blades can include a first wedge blade attached to the peripheral wall proximal to the first axial end to a location on the peripheral wall away from the first axial end and extending inward toward the rotation axis, a second wedge blade attached to the peripheral wall proximal to the second axial end to a location on the peripheral wall away from the second axial end and extending inward toward the rotation axis, at least one pair of blades forming a v-channel, and a splitter blade attached to the v-channel and oriented substantially perpendicular to the rotation axis and substantially dividing the mixing chamber. The at least one pair of blades includes a first lifter blade having a planar surface having a first lifter blade edge, a second lifter blade edge opposite the first lifter blade edge, a third lifter blade edge in contact with the first wedge blade, and a fourth lifter blade edge, and a second lifter blade having a planar surface having a fifth lifter blade edge, a sixth lifter blade edge opposite the fifth lifter blade edge, a seventh lifter blade edge in contact with the second wedge blade, and an eighth lifter blade edge in contact with the fourth lifter blade edge. The method can also include separating, by rotational motion about the rotation axis of a second set of blades within the cylindrical housing, the particulate mix into a third portion and a fourth portion, lifting, by rotational motion of the second set of blades about the rotation axis, the third portion above the fourth portion, directing, by rotational motion of the second set of blades about the rotation axis, the third portion toward the midpoint between the first axial end and the second axial end, directing, by rotational motion of the second set of blades about the rotation axis, the fourth portion toward the midpoint, and depositing, by rotational motion of the second set of blades about the rotation axis, the third portion on top of the fourth portion. The cylindrical housing can be rotated n times and the particulate mix can be mixed with a blending effect of 2ⁿ. The second set of blades can include a third wedge blade attached to the peripheral wall proximal to the first axial end to a location on the peripheral wall away from the first axial end and extending inward to the rotation axis, a fourth wedge blade attached to the peripheral wall proximal to the second axial end to a location on the peripheral wall away from the second axial end and extending inward to the rotation axis, at least one pair of blades forming a v-channel, and a splitter blade attached to the v-channel and oriented substantially perpendicular to the rotation axis and substantially dividing the mixing chamber. The at least one pair of blades can include a third lifter blade having a planar surface having a ninth lifter blade edge, a tenth lifter blade edge opposite the ninth lifter blade edge, an eleventh lifter blade edge in contact with the third wedge blade, and a twelfth lifter blade edge, and a fourth lifter blade having a planar surface having a thirteenth lifter blade edge, a fourteenth lifter blade edge opposite the thirteenth lifter blade edge, a fifteenth lifter blade edge in contact with the fourth wedge blade, and a sixteenth lifter blade edge in contact with the twelfth lifter blade edge.

In a third aspect, a rotary mixer includes a cylindrical housing defining a mixing chamber and a rotation axis, the cylindrical housing being rotatable about the rotation axis in a rotation direction and having a longitudinal midpoint, means for splitting a material into two parts along the rotation axis during rotation of the material in the rotary mixer, means for moving the material toward the longitudinal midpoint during the rotation of the material in the rotary mixer, and means for depositing the material in one of the two parts over the material in another of the two parts during the rotation of the material in the rotary mixer to cause the mixing of the material.

Various embodiments can include some, all, or none of the following features. The cylindrical housing can include a peripheral wall defining a main mixing chamber having a first axial end and a second axial end, the cylindrical housing being rotatable about the rotation axis. The means for moving the material toward the longitudinal midpoint can include a collection of wedge blades attached to the peripheral wall proximal to the first axial end and proximal to the second axial end to locations on the peripheral wall away from the first axial end and the second axial end, and extending inward to the rotation axis. The means for depositing the material can be one or more v-channels. The means for splitting a material into two parts can be a splitter blade attached to at least one of the one or more v-channels substantially perpendicular to the horizontal rotation axis and substantially dividing the mixing chamber.

The systems, apparatus and techniques described here may provide one or more of the following advantages. First, an apparatus can provide rapid homogenization of disparate solid particulate materials. Second, the apparatus' operating principles enable the devices to mix materials of widely varying particle sizes, densities, and shapes. Third, the apparatus can reliably achieve a substantially homogeneous and/or uniform mixture in a relatively short period of time.

The details of one or more implementations are set forth in the accompanying drawings and the description below. Other features and advantages will be apparent from the description and drawings, and from the claims.

### DESCRIPTION OF DRAWINGS

FIGS. 1-6 are views of an example of a rotary mixer for mixing particulate matter.

FIGS. 7-12 are views of another example of a rotary mixer for mixing particulate matter.

FIG. 13 is a diagram of an example of an apparatus for manipulating a rotary mixer.

FIG. 14 is flow chart that shows an example of a process for mixing particulate matter.

### DETAILED DESCRIPTION

In general, the apparatus use a technique of splitting and recombination that promotes efficient and effective mixing. The apparatus implement a collection of blades arranged within a cylindrical housing (e.g., a drum, barrel). The design is such that the material to be mixed is split into two substantially equal halves, and then as the cylinder rotates one of the halves continues to slide on the outer drum wall while the other half is raised above and over the first half, and is then dropped on top of the first half, completing a precise, controlled recombination of the material. In general, the mixing apparatus are implemented as industrial right circular cylindrical drums (e.g., 55 gallon steel drum) although in some embodiments the design can be implemented in cylindrical housings made of plastic, fiberboard, steel, stainless steel, or any other appropriate material. The cylindrical housings are fitted with blades positioned at predetermined positions and angles to accomplish the splitting and recombination of the material being mixed. In some embodiments, the cylindrical housings can range in size from as small as a quart or smaller, up to as large as the mixing requirements may require (e.g., dozens, hundreds, or thousands of cubic feet).

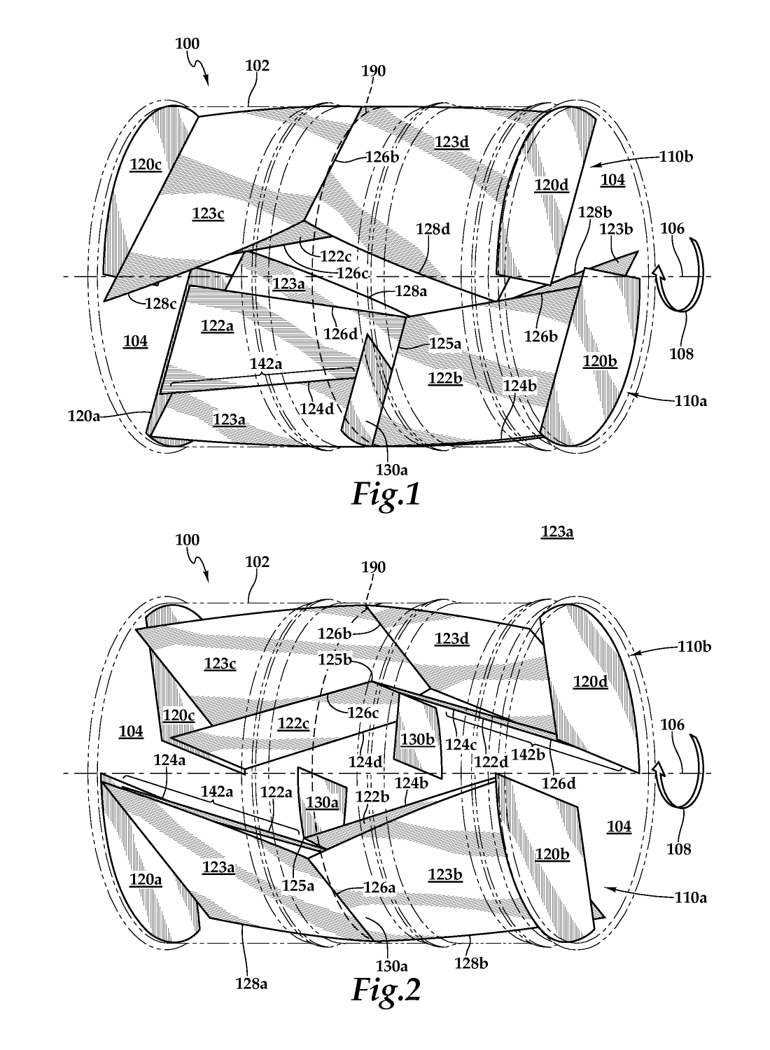

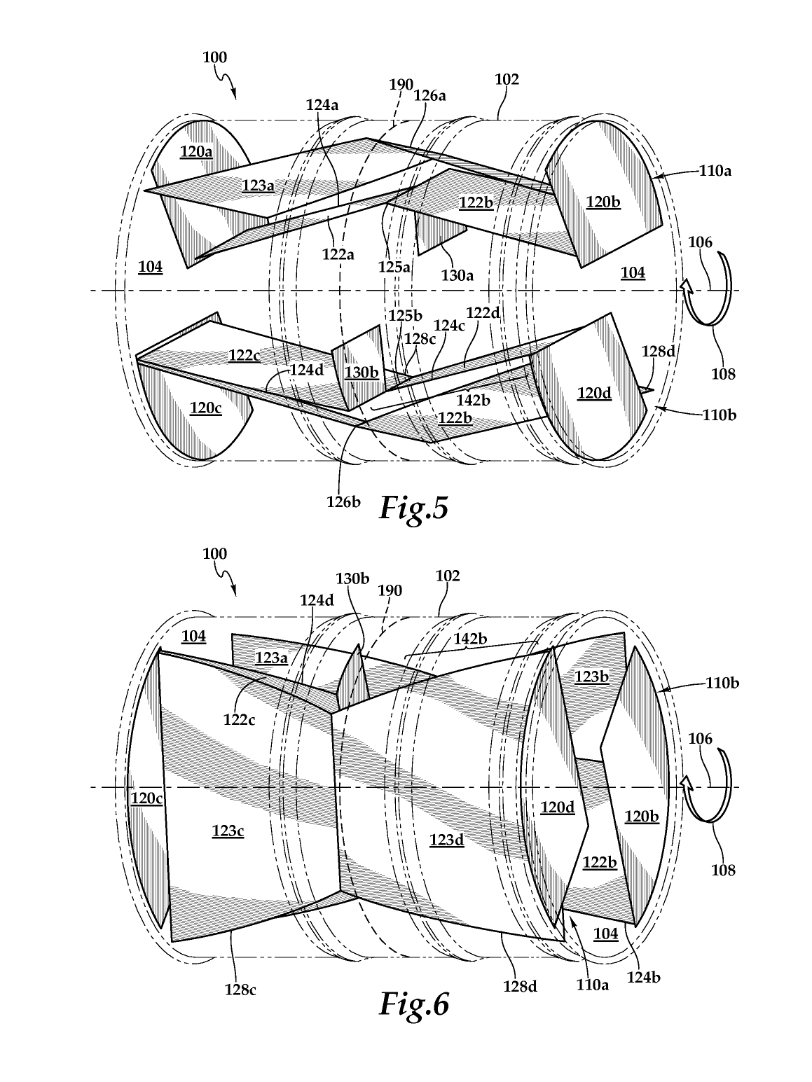

FIGS. 1-6 are views of an example of a rotary mixer (e.g., drum mixer) for mixing particulate matter. The rotary mixer 100 includes an outer housing 102. The outer housing 102 is formed as a hollow cylinder that defines a mixing chamber, the ends of which are covered by a pair of end caps 104. In some embodiments, the outer housing 102 may be a standard industrial drum. In some embodiments the end caps 104 can be standard industrial drum ends and/or lids. In some embodiments, one or both of the end caps 104 may be removable.

The rotary mixer 100 has two sets of blades 110a and 110b that split and recombine particulate matter twice for each rotation of the outer housing 102 along its cylindrical longitudinal axis 106. The set of blades 110a includes a pair of wedge blades 120a, 120b that are substantially in contact with the outer housing 102 and extend radially inward toward the axis 106. In some embodiments, one or both of the wedge blades 120a, 120b can be at least partly connected to the outer housing 102 (e.g., welded, glued, fastened). The wedge blades 120a, 120b are arranged as a wedge shape with its wide end open relative to the direction of rotation of the rotary mixer 100 as indicated by arrow 108. In some embodiments, the wedge blades 120a and 120b can be oriented relative to each other at angles ranging from about 1 degrees to 179 degrees. In some embodiments, the end caps 104 may be used without the wedge blades 120a and 120b.

A pair of lifter blades 122a, 122b extend between the wedge blades 120a, 120b to define a shallow v-channel 125a. The lifter blades 122a, 122b are arranged such that the v-channel 125a is radially further away from the axis 106 than the points from which the lifter blades 122a, 122b extend from the wedge blades 120a, 120b. The lifter blade 122a includes a leading edge 124a and a trailing edge 126a. In some embodiments, the lifter blades 122a and 122b can be arranged to contact each other at angles ranging from about 90 degrees to about 179 degrees.

The lifter blade 122b includes a leading edge 124b and a trailing edge 126b. The leading edges 124a and 124b lead the lifter blades 122a and 122b relative to rotation of the rotary mixer 100 in the direction of the arrow 108, and the trailing edges 126a and 126b follow the lifter blades 122a and 122b relative to rotation of the rotary mixer 100. The combined longitudinal width of the leading edges 124a and 124b is wider than the combined longitudinal width of the trailing edges 126a and 126b.

A pair of lifter blades 123a, 123b extends longitudinally between the wedge blades 120a, 120b to define another shallow v-channel 126a. The lifter blades 123a, 123b are arranged such that the v-channel 126a is radially further away from the axis 106 than the points from which the lifter blades 123a, 123b extend from the wedge blades 120a, 120b, and such that the v-channel 126a is suspended radially between the v-channel 125a and the outer housing 102. In some embodiments, the lifter blades 123a and 123b can be configured to meet at angles ranging from about 0 degrees to about 90 degrees. For example, a v-channel with a zero degree angle can be configured as a substantially planar lifting surface.

A splitter blade 130a extends radially inward from the v-channel 125a proximal to a midpoint 190 of the outer housing 102, partly into the interior of the outer housing 102. The splitter blade 130a is oriented substantially perpendicular (e.g., +/−20 degrees) to the axis 106. A leading aperture 142a is defined by the wedge blades 120a, 120b, the splitter blade 130a, and the outer housing 102 proximal the leading edge 124a.

The set of blades 110b includes a pair of wedge blades 120c, 120d that are substantially in contact with the outer housing 102 and extend radially inward toward the axis 106. In some embodiments, one or both of the wedge blades 120c, 120d can be at least partly connected to the outer housing 102 (e.g., welded, glued, fastened). The wedge blades 120c, 120d are arranged as a wedge shape with its wide end open relative to the direction of rotation of the rotary mixer 100 as indicated by arrow 108. In some embodiments, the wedge blades 120c and 120d can be oriented relative to each other at angles ranging from about 1 degree to 179 degrees. In some embodiments, the end caps 104 can be used without the wedge blades 120c and 120d.

A pair of lifter blades 122c, 122d extend between the wedge blades 120c, 120d to define a shallow v-channel 125b. The lifter blades 122c, 122d are arranged such that the v-channel 125b is radially further away from the axis 106 than the points from which the lifter blades 122c, 122d extend from the wedge blades 120c, 120d. The lifter blade 122c includes a leading edge 124c and a trailing edge 126c. The lifter blade 122d includes a leading edge 124d and a trailing edge 126d. The leading edges 124c and 124d lead the lifter blades 122c and 122d relative to rotation of the rotary mixer 100 in the direction of the arrow 108, and the trailing edges 126c and 126d follow the lifter blades 122c and 122d relative to rotation of the rotary mixer 100. The combined longitudinal width of the leading edges 124c and 124d is wider than the combined longitudinal width of the trailing edges 126c and 126d. In some embodiments, the lifter blades 122c and 122d can be arranged to contact each other at angles ranging from about 90 degrees to about 179 degrees.

A pair of lifter blades 123c, 123d extends longitudinally between the wedge blades 120c, 120d to define another shallow v-channel 126b. The lifter blades 123c, 123d are arranged such that the v-channel 126b is radially further away from the axis 106 than the points from which the lifter blades 123c, 123d extend from the wedge blades 120c, 120d, and such that the v-channel 126b is suspended radially between the v-channel 125b and the outer housing 102. In some embodiments, the lifter blades 123c and 123d can be configured to meet at angles ranging from about 0 degrees to about 90 degrees. For example, the lifter blades 123c and 123d can be configured as a single plate, forming a v-channel with zero angle.

A splitter blade 130b extends radially inward from the v-channel 125b proximal to the midpoint 190 of the outer housing 102, partly into the interior of the outer housing 102. The splitter blade 130b is oriented substantially perpendicular (e.g., +/−20 degrees) to the axis 106. A leading aperture 142b is defined by the wedge blades 120c, 120d, the splitter blade 130b, and the outer housing 102 proximal the leading edge 124c.

The blade set 110a and the blade set 110b are near mirror configurations of each other across the axis 106, except that the leading aperture 142a and the leading aperture 142b are on opposite sides of their respective splitter blades 130a, 130b relative to each other along the axis 106.

In operation, the rotary mixer 100 is at least partly filled with one or more forms of particulate matter (not shown). The end caps 104 are used to enclose the particulate matter within the interior of the outer housing 102. The rotary mixer 100 is oriented such that the axis 106 is substantially perpendicular to the pull of gravity (e.g., +/−5 to 10 degrees from horizontal relative to gravity). The particulate matter within the rotary mixer 100 falls under the pull of gravity, partly settling at the lowest points within the outer housing 102.

The rotary mixer 100 is then rotated about the axis 106. The particulate matter within the rotary mixer 100 is partly captured (e.g., scooped) by the wide end of the wedge formed by the wedge blades 120a, 120b. As the rotary mixer 100 continues to rotate, the splitter blade 130a divides the particulate matter substantially into two halves (e.g., approximately a 50%-50% split, +/−30%), with one half passing through the leading aperture 142a onto the lifter blades 123a and 123b, and the other half being lifted away from the outer housing 202 lifter blades 123a, 123b by the lifter blades 122a and 122b.

As the rotary mixer 100 continues to rotate, the half of the particulate on the lifter blades 122a, 122b will slide toward the trailing edges 126a and 126b. As the particulate matter slides, the wedge blades 120a and 120b and the slopes of the lifter blades 122a and 122b urge the material towards the v-channel 125a. The other half of the particulate on the lifter blades 123a and 123b will slide toward a pair of trailing edges 128a and 128b at the rotationally rearward ends of the lifter blades 123a, 123b. The particulate on the lifter blades 123a and 123b will also be urged towards the v-channel 126a by the wedge blades 120a and 120b and the slopes of the lifter blades 123a and 123b.

The lifter blades 122a and 122b act as a rotating shelf to raise one of the halves of the particulate matter above the other half relative to gravity. Eventually, the lifted half of the particulate matter will fall off the trailing edges 126a and 126b on top of the other half of the particulate matter (e.g., on the lifter blades 123a and 123b). The aforementioned processes occur during substantially one half of a rotation of the rotary mixer 100.

As the rotary mixer 100 continues to rotate, the blade set 110b performs substantially the same actions as the blade set 110a, scooping, splitting, lifting, and depositing the particulate material to cause further mixing. In some embodiments, because the rotary mixer 100 is recombining substantially equal halves of a quantity of particulate matter, the blending effect can be quantified as 2 to the nth power. For example, since the rotary mixer 100 contains two blade sets 110a, 110b that have substantially equal effect, the mixing achieved by one rotation of the rotary mixer 100 can be expressed mathematically as 2²=4, with 4 being the number of effective layers created by the rotation of the drum through one revolution. With 10 rotations of the rotary mixer 100 the effect (e.g., number of layers) can be 2¹⁰=1,048,576 (e.g., over a million). Similarly, with 20 rotations of the rotary mixer the effect can be 2⁴⁰=1.099×1012 (e.g., over 1 trillion).

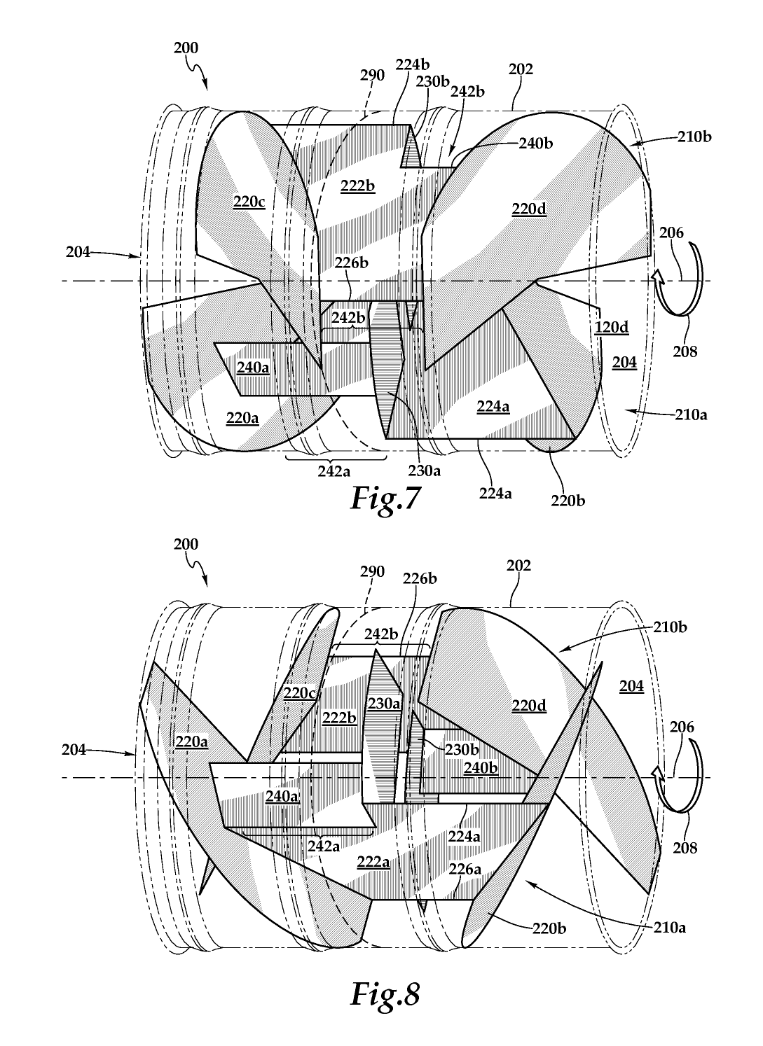

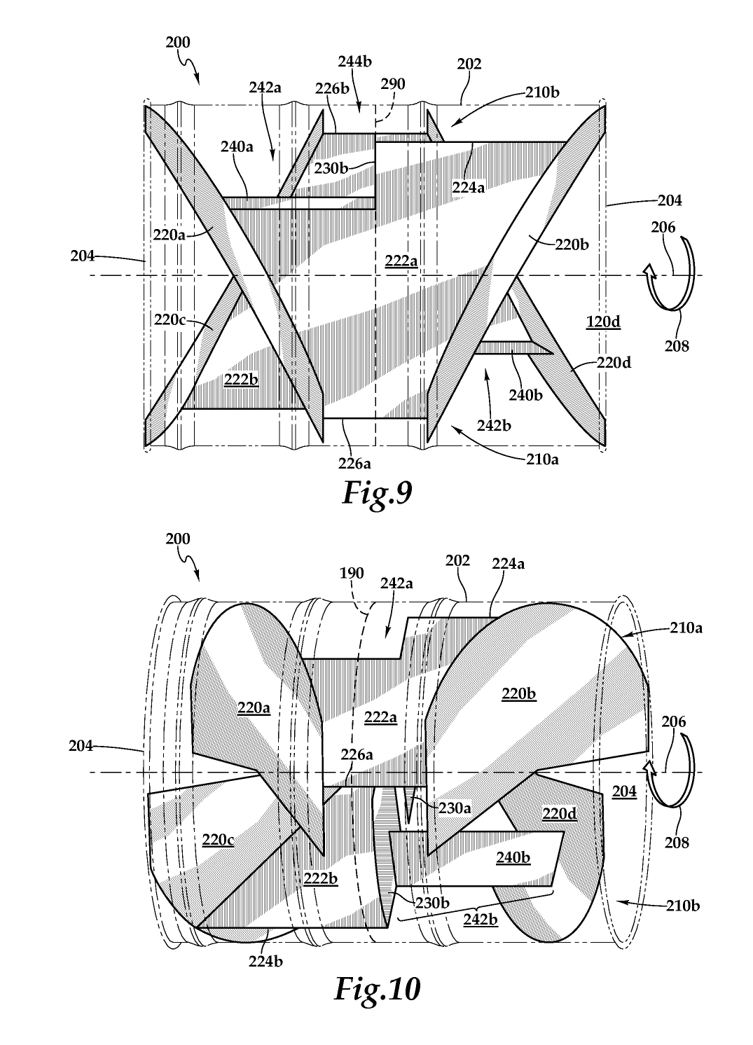

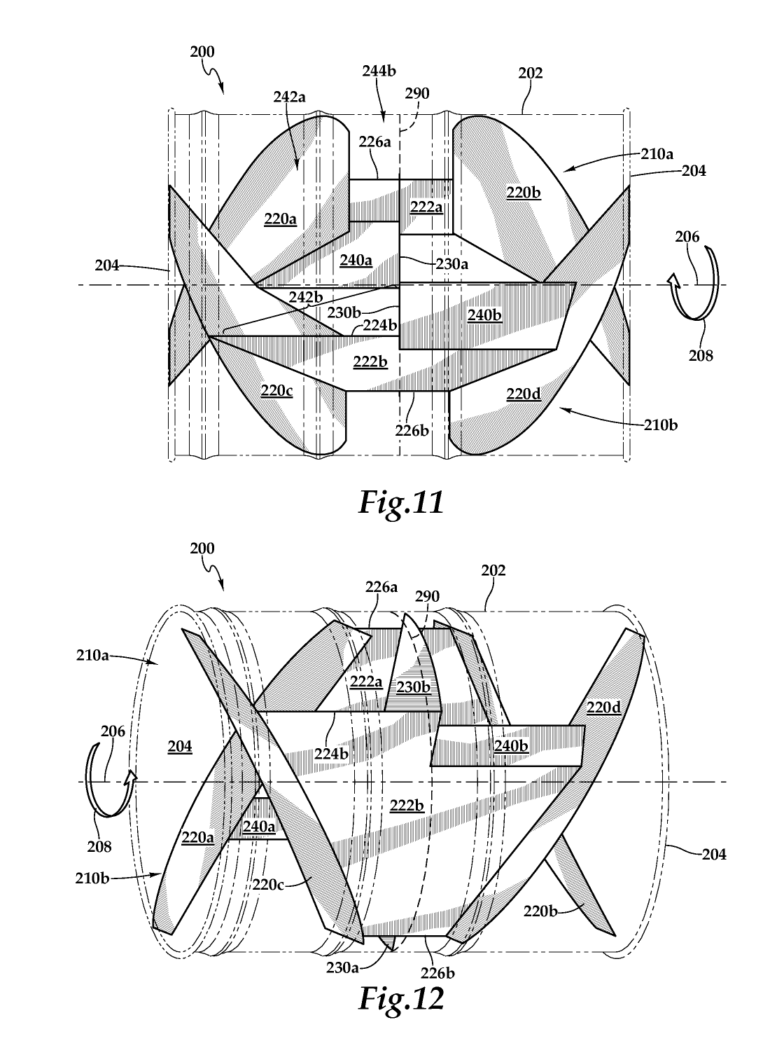

FIGS. 7-12 are views of another example of a rotary mixer 200 for mixing particulate matter. The rotary mixer 200 includes an outer housing 202. The outer housing 202 is formed as a hollow cylinder, the ends of which are covered by a pair of end caps 204. In some embodiments, the outer housing 202 may be a standard industrial drum. In some embodiments the end caps 204 can be standard industrial drum ends and/or lids. In some embodiments, one or both of the end caps 204 may be removable.

The rotary mixer 202 has two sets of blades 210a and 210b that split and recombine particulate matter twice for each rotation of the outer housing 202 along its cylindrical longitudinal axis 206. The set of blades 210a includes a pair of wedge blades 220a, 220b that are substantially in contact with the outer housing 202 and extend radially inward toward the axis 206. In some embodiments, one or both of the wedge blades 220a, 220b can be at least partly connected to the outer housing 202 (e.g., welded, glued, fastened). The wedge blades 220a, 220b are arranged as a wedge shape with its wide end open relative to the direction of rotation of the rotary mixer 200 as indicated by arrow 208.

A lifter blade 222a extends substantially parallel (e.g., +/−20 degrees) to the axis 206 between the wedge blades 220a, 220b. The lifter blade 222a includes a leading edge 224a and a trailing edge 226a. The leading edge 224a leads the lifter blade 222a relative to rotation of the rotary mixer 200 in the direction of the arrow 208, and the trailing edge 226a follows the lifter blade 222a relative to rotation of the rotary mixer 200. The leading edge 224a is wider than the trailing edge 226a.

A splitter blade 230a extends substantially perpendicular (e.g., +/−20 degrees) from the lifter blade 222a proximal to a midpoint 290 of the outer housing 202, and extends radially inward from the outer housing 202 partly into the interior of the outer housing 202. The splitter blade 230a is oriented substantially perpendicular (e.g., +/−20 degrees) to the axis 206. A blocker blade 240a extends substantially perpendicular (e.g., +/−20 degrees) from the lifter blade 222a partly into the interior of the outer housing 202. The blocker blade 240a is oriented substantially parallel (e.g., +/−20 degrees) to the axis 206.

A leading aperture 242a is defined by the wedge blades 220a, 220b, the splitter blade 230a, the blocker blade 240a, and the outer housing 202 proximal the leading edge 224a. A trailing aperture 244a is defined by wedge blades 220a, 220b, and the outer housing 202 proximal the trailing edge 226a.

The set of blades 210b diagonally mirrors the set of blades 210a across the axis 206. The set of blades 210b includes a pair of wedge blades 220c, 220d that are proximal to, or at least partly in contact with, the outer housing 202 and extend radially inward toward the axis 206. In some embodiments, one or both of the wedge blades 220c, 220d can be at least partly connected to the outer housing 202 (e.g., welded, glued, fastened). The wedge blades 220c, 220d are arranged as a wedge shape relative to the direction of rotation of the rotary mixer 200 as indicated by arrow 208.

A lifter blade 222b extends substantially parallel (e.g., +/−20 degrees) to the axis 206 between the wedge blades 220c, 220d. The lifter blade 222b includes a leading edge 224b and a trailing edge 226b. The leading edge 224b leads the lifter blade 222b relative to rotation of the rotary mixer 200 in the direction of the arrow 208, and the trailing edge 226b follows the lifter blade 222b relative to rotation of the rotary mixer 200. The leading edge 224b is wider than the trailing edge 226b.

A splitter blade 230b extends substantially perpendicular (e.g., +/−20 degrees) from the lifter blade 222b proximal to the midpoint 290 of the outer housing 202, and extends radially inward from the outer housing 202 partly into the interior of the outer housing 202. The splitter blade 230b is oriented substantially perpendicular (e.g., +/−20 degrees) to the axis 206. A blocker blade 240b extends substantially perpendicular (e.g., +/−20 degrees) from the lifter blade 222b partly into the interior of the outer housing 202. The blocker blade 240b is oriented substantially parallel (e.g., +/−20 degrees) to the axis 206.

A leading aperture 242b is defined by the wedge blades 220c, 220d, the splitter blade 230b, the blocker blade 240b, and the outer housing 202 proximal the leading edge 224b. A trailing aperture 244b is defined by wedge blades 220c, 220d, and the outer housing 202 proximal the trailing edge 226b.

The blade set 210a and the blade set 210b are near mirror configurations of each other across the axis 206, except that the leading aperture 242a and the blocker blade 240a, and the leading aperture 242b and the blocker blade 240b are on opposite sides of their respective splitter blades 230a, 230b relative to each other along the axis 206.

In operation, the rotary mixer 200 is at least partly filled with one or more forms of particulate matter (not shown). The end caps 204 are used to enclose the particulate matter within the interior of the outer housing 202. The rotary mixer 200 is oriented such that the axis 206 is substantially perpendicular to the pull of gravity (e.g., +/−10 degrees from horizontal relative to gravity). The particulate matter within the rotary mixer 200 falls under the pull of gravity, partly settling at the lowest points within the outer housing 202.

The rotary mixer 200 is then rotated about the axis 206. The particulate matter within the rotary mixer 200 is partly captured (e.g., scooped) by the wide end of the wedge formed by the wedge blades 220a, 220b. As the rotary mixer 200 continues to rotate, the splitter blade 230a divides the particulate matter substantially into two halves (e.g., approximately a 50%-50% split, +/−30%, with one half passing through the leading aperture 242a and remaining proximate the outer housing 202, and the other half being lifted away from the outer housing 202 by the lifter blade 222a.

As the rotary mixer 200 continues to rotate, the half of the particulate on the lifter blade 222a will slide toward the trailing aperture 244a. As the particulate matter slides, the wedge blades 220a and 220b urge the material towards the longitudinal midpoint 290 of the rotary mixer 200. The other half of the particulate along the outer housing 202 will slide toward the trailing aperture 244a as well, and will be urged towards the longitudinal midpoint 290 of the rotary mixer 200 by the wedge blades 220a and 220b as well. The lifter blade 222a acts as a rotating shelf to raise one of the halves above the other relative to gravity. Eventually, the lifted half of the particulate matter will fall though the trailing aperture 244b on top of the other half of the particulate matter. The aforementioned processes occur during substantially one half of a rotation of the rotary mixer 200.

As the rotary mixer 200 continues to rotate, the blade set 210b performs substantially the same actions as the blade set 210a, scooping, splitting, lifting, and depositing the particulate material to cause further mixing. In some embodiments, because the rotary mixer 200 is recombining substantially equal halves of a quantity of particulate matter, the blending effect can be quantified as 2 to the nth power. For example, since the rotary mixer 200 contains two blade sets 210a, 210b that have substantially equal effect, the mixing achieved by one rotation of the rotary mixer 200 can be expressed mathematically as 2²=4, with 4 being the number of layers through one revolution. With 10 rotations of the rotary mixer the effect (e.g., number of layers) can be 2¹⁰=1,048,576 (e.g., over a million). Similarly, with 20 rotations of the rotary mixer the effect can be 2⁴⁰=1.099×10¹² (e.g., over 1 trillion).

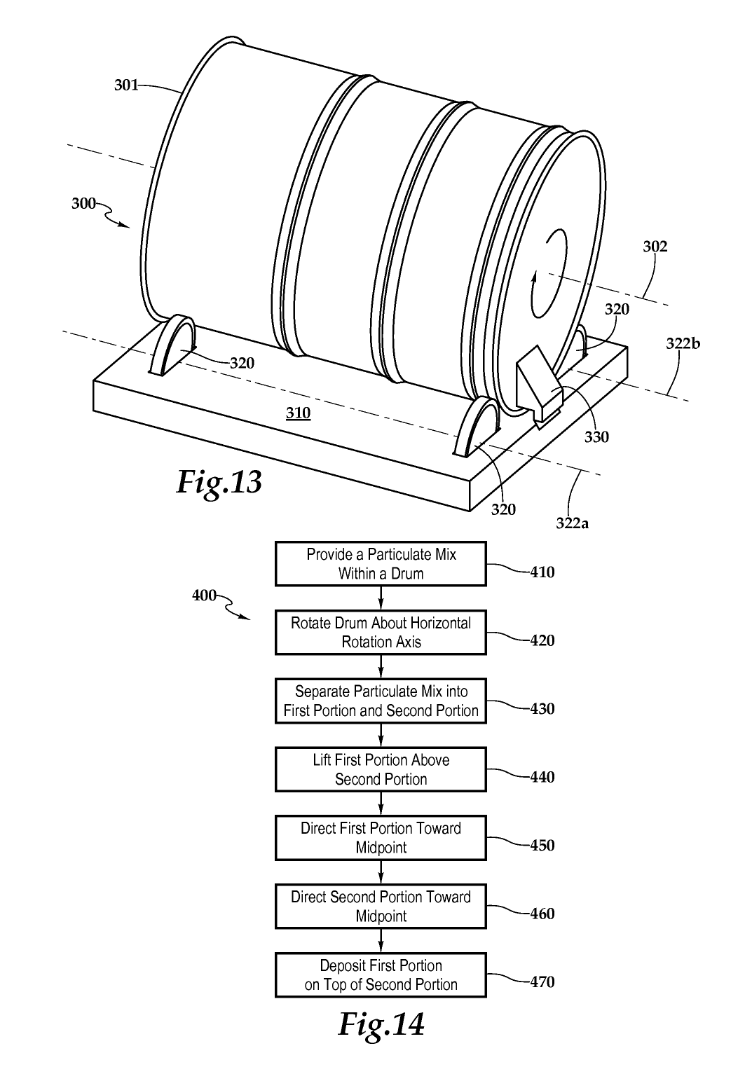

FIG. 13 is a diagram of an example of an apparatus 300 for manipulating a rotary mixer 301. In some embodiments, the rotary mixer 301 can be the rotary mixer 100 of FIGS. 1-6 or the rotary mixer 200 of FIGS. 7-12.

The apparatus 300 includes a support base 310 and a collection of rollers 320. In some embodiments, the support base 310 can include power, control, structural supports, and motors for the operation of the rollers 320. The rollers 320 are arranged to support and rotate the rotary mixer 301 about an axis 302. A first pair of the rollers 320 is arranged to rotate about a common axis 322a, and a second pair of the rollers 320 is arranged to rotate about a common axis 322a spaced apart and parallel to the common axis 322a.

In use, particulate matter can be placed in the rotary mixer 301. The rotary mixer 301 is placed horizontally upon the rollers 320. In some embodiments, the rotary mixer 301 can be oriented within a range of about +/−5 to 10 degrees from horizontal (e.g., perpendicular to gravity). The rollers 320 are then actuated to roll the rotary mixer 301 about the axis 302. The rotation of the rotary mixer 301 causes the particulate matter to interact with blades arranged within the interior of the rotary mixer 301 to cause a mixing of the particulate matter.

The rotary mixer 301 can also include a spout 330. The spout 330 can be opened and closed to allow for the entry and exit of particulate matter into and out of the interior of the rotary mixer 301. In some embodiments, the rotary mixer 301 may be rotated to locate the spout 330 at the relative top of the rotary mixer 301 (e.g., relative to gravity as the rotary mixer 301 rests horizontally). For example, the spout 330 may be rotated upward when particulate matter is to be introduced into the rotary mixer 301. In some embodiments, the rotary mixer 301 may be rotated to locate the spout 330 at the relative bottom of the rotary mixer 301 (e.g., relative to gravity as the rotary mixer 301 rests horizontally). For example, the spout 330 may be rotated downward when particulate matter is to be removed from the rotary mixer 301 (e.g., to flow or pour out).

FIG. 14 is flow chart that shows an example of a process 400 for mixing particulate matter. In some implementations, the process is performed using the rotary mixers 100, 200, or 300 of FIGS. 1-13. At 410 a particulate mix including one or more particulates is provided within a cylindrical housing having a peripheral wall defining a mixing chamber having a first axial end and a second axial end and at least one collection of mixing blades, the cylindrical housing being rotatable about a substantially horizontal (e.g., +/−5 to 10 degrees perpendicular to gravity) rotation axis extending between the first axial end and the second axial end. For example, the rotary mixer 100 can be provided, and the rotary mixer can hold a mixture of one or more particulates.

At 420, the cylindrical housing is rotated about the horizontal rotation axis. For example, the rotary mixer 100 can be rotated about the axis 106.

At 430, the particulate mix is separated into a first portion and a second portion by rotational motion of a first collection of mixing blades. For example, FIG. 1 shows the splitter blade 130a in a position that can divide the particulate mix as the rotary mixer 100 rotates.

At 440, the first portion is lifted above the second portion by rotational motion of the first collection of mixing blades. For example, as shown in FIG. 2, one of the portions divided by the splitter blade 130a can be lifted by the lifter blades 122a and 122b above the other portion as the rotary mixer 100 rotates.

At 450 the first portion is directed toward a midpoint between the first axial end and the second axial end by rotational motion of the first collection of mixing blades. For example, as shown in FIG. 2, the wedge blades 120a, 120b, and the slopes of the lifter blades 122a, 122b can direct the upper portion of the particulate mix toward the v-channel 125a as the rotary mixer 100 rotates.

At 460, the second portion is directed toward the midpoint by rotational motion of the first collection of mixing blades. For example, as shown in FIG. 2, the wedge blades 120a, 120b, and the slopes of the lifter blades 123a, 123b can direct the upper portion of the particulate mix toward the v-channel 126a as the rotary mixer 100 rotates.

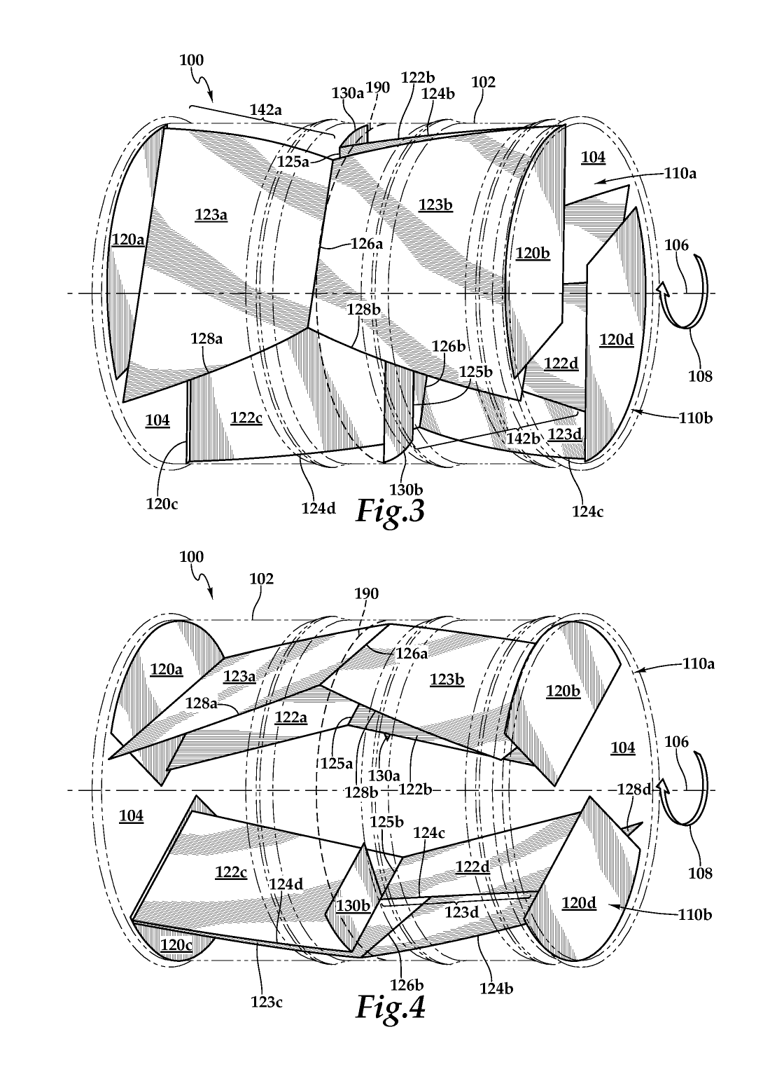

At 470, the first portion is deposited on top of the second portion by rotational motion of the first collection of mixing blades. For example, FIG. 3 shows the set of blades 110a in a position in which the portion of the particulate mix on the lifter blades 122a and 122b can slide off the trailing edges 126a and 126b onto the portion of the particulate mix supported by the lifter blades 123a and 123b.

In some implementations, steps 420-470 may be repeated a predetermined number of times or until a predetermined amount of mixing has been achieved. For example, with 10 rotations of the rotary mixer the effect can be 2¹⁰=1,048,576 (e.g., over a million). In some implementations, after 470, the particulate mix may be removed from the rotary mixer. For example, one or both of the end caps 104 may be removed to provide access to the particulate mix, or the particulate mix may be poured out through a spout such as the spout 330 of FIG. 3.

In some embodiments, the process 400 can also include separating by rotational motion of a second collection of mixing blades the particulate mix into a third portion and a fourth portion, lifting by rotational motion of the third collection of mixing blades the third portion above the fourth portion, directing by rotational motion of the second collection of mixing blades the third portion toward the midpoint between the first axial end and the second axial end, directing by rotational motion of the second collection of mixing blades the fourth portion toward the midpoint, and depositing by rotational motion of the second collection of mixing blades the third portion on top of the fourth portion. For example, the set of blades 110b can split, lift, direct, and deposit the particulate matter a second time per rotation of the rotary mixer 100, in addition to the mixing done by the set of blades 110a. In some embodiments, the rotary mixer 100 can be rotated n times and the particulate mix can mixed with a blending effect of 2ⁿ. For example, the sets of blades 110a and 110b can both be used, and if the rotary mixer 100 is rotated ten times then the mixing effect can be 2¹⁰=1,048,576.

In some embodiments, the rotary mixers 100, 200, and 300 of FIGS. 1, 2, and 3 can be modified for continuous (e.g., flow-through) operation. For example, one or more of the rotary mixers 100, with the end caps 104 omitted, can be assembled end-to-end along a shared rotational axis. The assembly can be elevated at one axial end relative to gravity and rotated about the shared rotational axis. One or more particulates can be poured into the upper end of the assembly, and the particulates can be mixed by rotation of the assembly as the mix is also drawn longitudinally downward by gravity along the assembly. The mix can then exit the assembly at the lower axial end.

Although a few implementations have been described in detail above, other modifications are possible. For example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A rotary mixer comprising:
a cylindrical housing comprising a peripheral wall defining a mixing chamber having a first axial end and a second axial end and defining a rotation axis, the cylindrical housing being rotatable about the rotation axis in a rotation direction and having a longitudinal midpoint;
a set of blades within the cylindrical housing, wherein at least one pair of blades of the set of blades forms an angle with respect to each other, and at least one blade of the set of blades is shorter than another blade of the set of blades in the rotation direction; and
a splitter blade located within the cylindrical housing with respect to the longitudinal midpoint and the angle to divide material in the mixing chamber between the at least one blade of the set of blades and the other blade of the set of blades, as the cylindrical housing is rotated about the rotation axis.

2. The rotary mixer of claim 1, wherein the at least one pair of blades comprises a first wedge blade and a second wedge blade, the first wedge blade being attached to the peripheral wall proximal to the first axial end to a location on the peripheral wall away from the first axial end and extending inward toward the rotation axis, and the second wedge blade being attached to the peripheral wall proximal to the second axial end to a location on the peripheral wall away from the second axial end and extending inward toward the rotation axis.

3. The rotary mixer of claim 2, wherein the at least one pair of blades comprises a third wedge blade and a fourth wedge blade, the third wedge blade being attached to the peripheral wall proximal to the first axial end to a location on the peripheral wall away from the first axial end and extending inward toward the rotation axis, and the fourth wedge blade being attached to the peripheral wall proximal to the second axial end to a location on the peripheral wall away from the second axial end and extending inward toward the rotation axis.

4. The rotary mixer of claim 1, wherein the at least one pair of blades comprises the at least one blade of the set of blades and the other blade of the set of blades, which are a first lifter blade and a second lifter blade that come together to form a v-channel.

5. The rotary mixer of claim 4, wherein the set of blades comprise a first wedge blade and a second wedge blade, the first wedge blade being attached to the first lifter blade and to the peripheral wall proximal to the first axial end, and the second wedge blade being attached to the second lifter blade and to the peripheral wall proximal to the second axial end.

6. The rotary mixer of claim 5, wherein the v-channel is a first v-channel, and the at least one pair of blades comprises a third lifter blade and a fourth lifter blade that come together to form a second v-channel suspended radially between the first v-channel and the cylindrical housing.

7. The rotary mixer of claim 4, wherein the at least one pair of blades comprises a third lifter blade and a fourth lifter blade that come together to form a second v-channel.

8. The rotary mixer of claim 7, wherein the set of blades comprise a first wedge blade and a second wedge blade, the first wedge blade being attached to the third lifter blade and to the peripheral wall proximal to the first axial end, and the second wedge blade being attached to the fourth lifter blade and to the peripheral wall proximal to the second axial end.

9. The rotary mixer of claim 7, wherein the at least one pair of blades comprises a fifth lifter blade and a sixth lifter blade that come together to form a third v-channel suspended radially between the second v-channel and the cylindrical housing.

10. A method of mixing particulate matter, the method comprising:
providing a particulate mix comprising one or more particulates within a cylindrical housing having a peripheral wall defining a mixing chamber having a first axial end and a second axial end and defining a rotation axis, the cylindrical housing being rotatable about the rotation axis extending between the first axial end and the second axial end and having a longitudinal midpoint, and at least one set of blades within the cylindrical housing;
rotating the cylindrical housing about the rotation axis;
separating, by rotational motion of the set of blades about the rotation axis, the particulate mix into a first portion and a second portion;
lifting, by rotational motion of the set of blades about the rotation axis, the first portion above the second portion;
directing, by rotational motion of the set of blades about the rotation axis, the first portion toward the midpoint;
directing, by rotational motion of the set of blades about the rotation axis, the second portion toward the midpoint; and
depositing, by rotational motion of the set of blades about the rotation axis, the first portion on top of the second portion.

11. The method of claim 10, wherein the set of blades comprises:
a first wedge blade attached to the peripheral wall proximal to the first axial end to a location on the peripheral wall away from the first axial end and extending inward toward the rotation axis;
a second wedge blade attached to the peripheral wall proximal to the second axial end to a location on the peripheral wall away from the second axial end and extending inward toward the rotation axis;
at least one pair of blades forming a v-channel; and
a splitter blade attached to the v-channel and oriented substantially perpendicular to the rotation axis and substantially dividing the mixing chamber.

12. The method of claim 11, wherein the at least one pair of blades comprises:
a first lifter blade having a planar surface having a first lifter blade edge, a second lifter blade edge opposite the first lifter blade edge, a third lifter blade edge in contact with the first wedge blade, and a fourth lifter blade edge; and
a second lifter blade having a planar surface having a fifth lifter blade edge, a sixth lifter blade edge opposite the fifth lifter blade edge, a seventh lifter blade edge in contact with the second wedge blade, and an eighth lifter blade edge in contact with the fourth lifter blade edge.

13. The method of claim 10, further comprising:
separating, by rotational motion about the rotation axis of a second set of blades within the cylindrical housing, the particulate mix into a third portion and a fourth portion;
lifting, by rotational motion of the second set of blades about the rotation axis, the third portion above the fourth portion;
directing, by rotational motion of the second set of blades about the rotation axis, the third portion toward the midpoint between the first axial end and the second axial end;
directing, by rotational motion of the second set of blades about the rotation axis, the fourth portion toward the midpoint; and
depositing, by rotational motion of the second set of blades about the rotation axis, the third portion on top of the fourth portion.

14. The method of claim 13, wherein the cylindrical housing is rotated n times and the particulate mix is mixed with a blending effect of 2ⁿ.

15. The method of claim 13, wherein the second set of blades comprises:
a third wedge blade attached to the peripheral wall proximal to the first axial end to a location on the peripheral wall away from the first axial end and extending inward to the rotation axis;
a fourth wedge blade attached to the peripheral wall proximal to the second axial end to a location on the peripheral wall away from the second axial end and extending inward to the rotation axis;
at least one pair of blades forming a v-channel; and
a splitter blade attached to the v-channel and oriented substantially perpendicular to the rotation axis and substantially dividing the mixing chamber.

16. The method of claim 15, wherein the at least one pair of blades comprises:
a third lifter blade having a planar surface having a ninth lifter blade edge, a tenth lifter blade edge opposite the ninth lifter blade edge, an eleventh lifter blade edge in contact with the third wedge blade, and a twelfth lifter blade edge; and
a fourth lifter blade having a planar surface having a thirteenth lifter blade edge, a fourteenth lifter blade edge opposite the thirteenth lifter blade edge, a fifteenth lifter blade edge in contact with the fourth wedge blade, and a sixteenth lifter blade edge in contact with the twelfth lifter blade edge.

17. A rotary mixer comprising:
a cylindrical housing defining a mixing chamber and a rotation axis, the cylindrical housing being rotatable about the rotation axis in a rotation direction and having a longitudinal midpoint;
means for splitting a material into two parts along the rotation axis during rotation of the material in the rotary mixer;
means for moving the material toward the longitudinal midpoint during the rotation of the material in the rotary mixer; and
means for depositing the material in one of the two parts over the material in another of the two parts during the rotation of the material in the rotary mixer to cause the mixing of the material.

18. The rotary mixer of claim 17, wherein the cylindrical housing comprises a peripheral wall defining a main mixing chamber having a first axial end and a second axial end, the cylindrical housing being rotatable about the rotation axis.

19. The rotary mixer of claim 18, wherein the means for moving the material toward the longitudinal midpoint comprises a collection of wedge blades attached to the peripheral wall proximal to the first axial end and proximal to the second axial end to locations on the peripheral wall away from the first axial end and the second axial end, and extending inward to the rotation axis.

20. The rotary mixer of claim 17, wherein the means for depositing the material comprises one or more v-channels.

21. The rotary mixer of claim 20, wherein the means for splitting a material into two parts comprises a splitter blade attached to at least one of the one or more v-channels substantially perpendicular to the horizontal rotation axis and substantially dividing the mixing chamber.
